(19) United States
(12) Patent Application Publication
(10) Pub. No.: US 2022/0201639 A1
(43) Pub. Date: Jun. 23, 2022

(54) IMS REGISTRATION

(71) Applicant: Telefonaktiebolaget LM Ericsson (publ), Stockholm (SE)

(72) Inventors: Afshin ABTIN, Sollentuna (SE); Ralf KELLER, Würselen (DE); Mattias DAHLQVIST, Stockholm (SE)

(73) Assignee: Telefonaktiebolaget LM Ericsson (publ), Stockholm (SE)

(21) Appl. No.: 17/600,942

(22) PCT Filed: Apr. 2, 2019
(86) PCT No.: PCT/SE2019/050301

§ 371 Date: Oct. 1, 2021

(51) Int. Cl. H04W 60/00; H04L 65/1016; H04L 65/1045

(52) U.S. Cl. CPC H04W 60/00; H04L 65/105; H04L 65/1016

(57) ABSTRACT

A UE that provides to the core network information indicating the particular IMS type (e.g. 5G IMS) that should serve the UE. For example, in one embodiment there is provided a method performed by a UE for registering with an IMS. The method includes the UE, prior to initiating an IMS registration procedure, transmitting a request message comprising IMS information indicating a particular IMS type (e.g. 5G IMS) that should serve the UE.

### TECHNICAL FIELD

Disclosed are embodiments related to Internet Protocol (IP) Multimedia Subsystem (IMS) registration.

### BACKGROUND

IMS offers a standardized way to deliver convenient IP-based consumer and enterprise services. The role of IMS is to provide a secure and reliable means for terminals and applications to reach, negotiate and communicate with each other. Typically, an IMS network comprises two main nodes: the Call Session Control Function (CSCF) and the Home Subscriber Server (HSS). The CSCF is generally considered the heart of the IMS architecture and is used to process Session Initiation Protocol (SIP) signaling. A main function of the CSCF is to provide session control for terminals and applications using the IMS network. Session control may include the secure routing of the SIP messages, subsequent monitoring of the SIP sessions and communicating with the policy architecture to support media authorization. Typically, a CSCF is divided into three parts: 1) the Serving CSCF (S-CSCF), 2) the Interrogating CSCF (I-CSCF), and 3) the Proxy CSCS (P-CSCF). In the context of voice in IMS an additional important function within an IMS network is the telephony application server (TAS).

The P-CSCF is the first point of contact that the IMS domain presents to a user equipment (UE) (i.e., any device capable of wireless communication with an access network node (e.g., base station) of an access network (e.g., a radio access network (RAN)). The P-CSCF functions as a proxy server for the UE; all SIP signaling traffic to and from the UE typically goes through the P-CSCF. The P-CSCF validates and then forwards requests from the user equipment and then processes and forwards the responses to the user equipment.

Voice services in the 5G System (5GS) will be provided using IMS based services similarly to the way voice service in the 4G System (i.e., VoLTE) is provided today. Due to coverage situation for the 5G access network (5G-AN), interworking with the 4G Evolved Packet System (EPS) will be needed with seamless mobility to/from EPS in most, if not all, deployments. 3GPP specifications covering the 5G core network (5GC) and IMS aspects of 5G are TS 23.501 and 23.502 as well as TS 23.228 and TS 24.229. VoLTE User Network Interfaces (UNI) is profiled in GSMA PRD IR.92 which is generally based on 3GPP Release 8 and Voice in 5GS will be profiled in GSMA NG.114 which will be based on 3GPP Release 15.

Similar to VoLTE where, during IMS PDN establishment, the network (e.g., Packet Gateway—PGW) will provide the UE with the P-CSCF addresses (e.g., IP addresses or fully qualified domain names (FQDNs)) which is used by the SIP stack of the UE to start IMS Registration procedures, 5GC will also provide the P-CSCF addresses to the UE during IMS PDU session establishment. This procedure is referred to as P-CSCF Discovery. TS 23.502 also defined 5GC interworking with EPC where MME in EPC can select a SMF with S5 capability (referred to as SMF+PGW-C in 3GPP).

### SUMMARY

Some network operators are planning to introduce voice in 5GS using a separate IMS deployment from the one used for voice in the 4G system (e.g., VoLTE). These operators are doing this to avoid impacting the existing VoLTE deployment. The number of 5G subscribers will initially be low and by using a dedicated IMS system the operational impacts of a general upgrade of the IMS system in all redundant sites can be avoided. It also allows the network operators to select a different vendor for the dedicated IMS systems (which may be a 5G IMS) than for the 4G IMS systems. Accordingly, this implies that the network operators will operate an IMS system with legacy 4G and VoLTE capability in parallel with a dedicated IMS system (e.g., a 5G enabled IMS system compliant to 3GPP Release 15).

In some embodiments, a 5G capable UE, with 5G subscription would need to be served by the 5G IMS while a legacy 4G VoLTE UE would need to be served by the legacy 4G IMS. Which IMS to use for a given UE is selected, as mentioned above, using P-CSCF Discovery procedures performed by SMF during IMS PDU session setup.

Certain challenges exist. For example, currently it is not possible for the SMF to consider the UE's IMS capabilities (e.g. if compliant to IR.92 only or NG.114) to select different P-CSCF lists to provide to the UE. Additionally, such differentiation cannot be based on current RAT Type (e.g. E-UTRAN vs. NR) because a VoLTE UE will use E-UTRAN (LTE) but a 5G Voice UE may also start in E-UTRAN coverage. There will be also the case that the subscriber has a 4G/VoLTE subscription but has a UE that supports 5GS. In this case, the network should configure the UE to refrain from indicating that it is 5G NAS capable or the network has to take subscription/roaming agreement information into account.

Accordingly, in one aspect, this disclosure proposes a UE (e.g., a UE compliant with NG 114) that provides to the core network information indicating the particular IMS type (e.g. 5G IMS) that should serve the UE. For example, in one embodiment there is provided a method performed by a UE for registering with an IMS. The method includes the UE, prior to initiating an IMS registration procedure, transmitting a request message comprising IMS information indicating a particular IMS type (e.g. 5G IMS) that should serve the UE. The method also includes the UE receiving a response message, the response message comprising a set of one or more addresses (e.g., IP addresses and/or domain names), wherein each address included in the set corresponds to a control function that operates within an IMS of the particular IMS type. The method also includes the UE using one of the received addresses to transmit a registration message to the control function corresponding to the address.

In another aspect there is provided a method performed by a session management function (SMF) for enabling a UE to register with an IMS. The method includes the SMF receiving a first message transmitted by an MME serving the UE, wherein the first message comprises a request for an address of an IMS control function and the first message indicates a particular IMS type (e.g. 5G IMS) that should serve the UE. The method also includes the SMF determining, based on the first message, the particular IMS type (e.g. 5G IMS) that should serve the UE. The method also includes the SMF, after determining the particular IMS type (e.g. 5G IMS) that should serve the UE, sending to the MME a second message comprising a first set of one or more addresses, wherein each address included in the first set of addresses corresponds to a control function that operates within an IMS of the particular IMS type.

In another aspect there is provided a computer program comprising instructions for adapting an apparatus to perform any one of the methods described herein. In another aspect there is a carrier containing the computer program, wherein the carrier is one of an electronic signal, optical signal, radio signal, or compute readable storage medium.

An advantage of the above embodiments is that, without such capability, it cannot be ensured that VoLTE UEs will be served by legacy 4G IMS and 5G UEs with 5G subscription will be served with 5G IMS. Additionally, due to different baselines in UE and IMS for 3GPP for 4G (IR.92 and 3GPp Rel 8) vs. 5G (NG.114 and 3GPP rel. 15), incompatibilities in term of procedures may occur.

### BRIEF DESCRIPTION OF THE DRAWINGS

The accompanying drawings, which are incorporated herein and form part of the specification, illustrate various embodiments.

FIG. 1 illustrates a system 100 according to an embodiment.

FIG. 2 illustrates some entities of a core network according to an embodiment.

FIG. 3 is a message flow diagram illustrating a registration procedure.

FIG. 4 is a flow chart illustrating a process according to an embodiment.

FIG. 5 is a flow chart illustrating a process according to an embodiment.

FIG. 6 is a block diagram illustrating a UE according to an embodiment.

FIG. 7 is a block diagram illustrating a session management function according to an embodiment.

### DETAILED DESCRIPTION

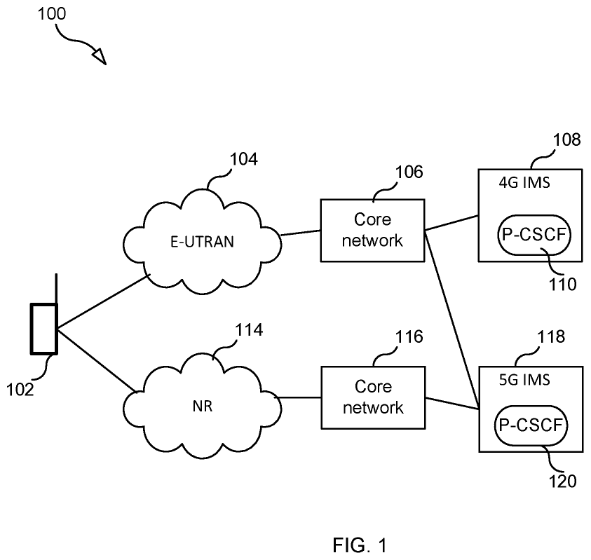

FIG. 1 illustrates a system 100 according to an embodiment. System 100 includes a 5G capable UE 102. As illustrated in FIG. 1, UE 102 can access a 4G IMS 108 via E-UTRAN 104 and a core network 106 and UE 102 can access either 4G IMS 108 or 5G IMS 118 via a 5G access network (“NR”) 114 and a core network 116. 4G IMS 108 and 5G IMS 118 each include various IMS call session control functions (CSCFs). For example, as shown, 4G IMS 108 and 5G IMS 118 include P-CSCF 110 and a P-CSCF 120, respectively.

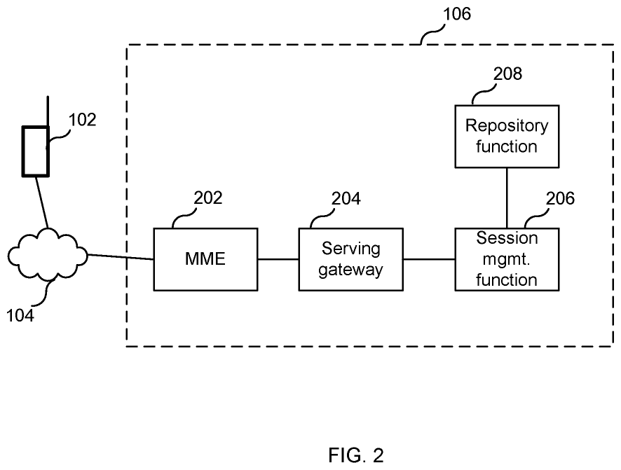

FIG. 2 illustrates various entities within core network 106. In one embodiment, core network 106 includes an MME 202, a serving gateway (SGW) 204, a session management function (SMF) (e.g., a 3GPP 5G SMF or a control plane of a 3GPP 4G PGW (PGW-C)), and a repository function (RF) 208 (e.g., a 3GPP 5G Network Repository Function (NRF)).

Advantageously, in some embodiments, UE 102 includes not 5G NAS capability indication in an IMS PDN session setup message sent to MME 202 but also includes in the message information (e.g., “IMS Voice in 5GS capable.”) indicating the type of IMS (e.g., 5G IMS) that should server UE 102. MME when selecting an SMF also provides “IMS Voice in 5GS capable” indication to the selected SMF 206 (e.g., PGW-C) (via SGW 204) after taking into account whether IMS voice is possible at all for UE 102 (based on roaming agreement, IMS APN in subscriber data, local policy or even additional new indication from HSS/UDM—proposed in 3GPP). The SMF 206, based on the IMS type indication, provides UE 102 with a P-CSCF addresses from 4G P-CSCF lists or 5G P-CSCF list. In some embodiments, SMF 206 applies a simple policy—i.e., the SMF provides 5G IMS addresses only if the UE is clearly indicated to support 5G IMS; in all other cases, 4G IMS addresses are provided. In case the P-CSCF addresses are discovered via NRF as proposed in 3GPP TR 23.794 section 6.18, then the SMF may need to discover either only 4G IMS addresses or only 5G IMS addresses for this UE. This would imply that P-CSCF during its NRF Registration procedure to provide in “4G” Vs. “5G” capability indication also. This is to ensure that a NG.114 UE on E-UTRAN attaching to network will be served by 5G IMS and a legacy VoLTE IR.92 UE will be served by existing deployed 4G IMS. With the extension in NRF for P-CSCF Discovery, additionally the selection mechanism in SMF will require less manual configuration and avoid potential errors and enable higher automation.

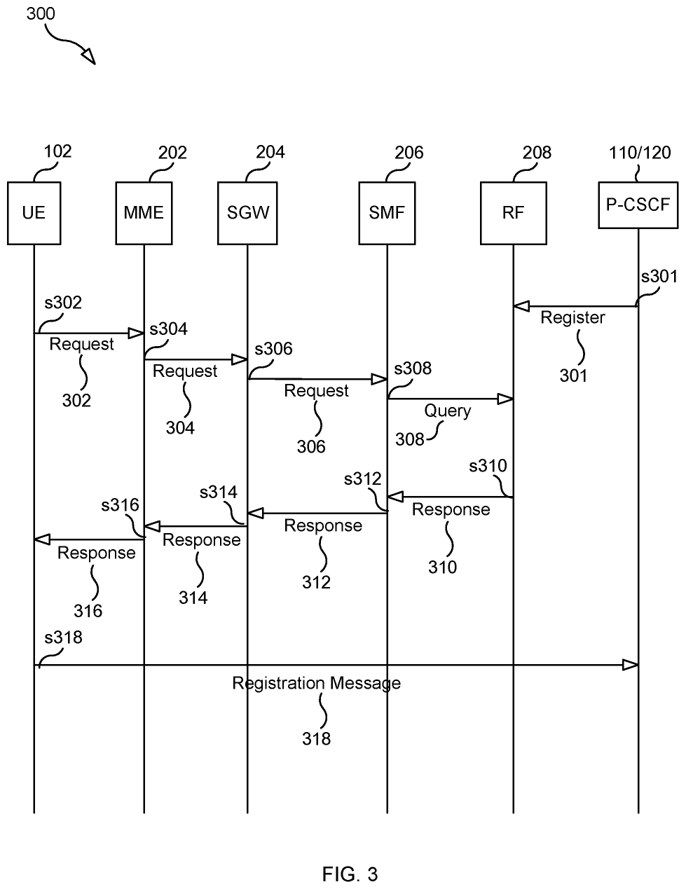

FIG. 3 is a message flow diagram illustrating a process according to an embodiment. The process may begin with step s301.

Step s301 comprises each P-CSCF 110/120 sending to RF 208 a registration message (e.g., a 3GPP 5G Nnrf_NFManagement_NFRegister Request message) that indicates the type of IMS within which the P-CSCF operates. For example, P-CSCF 110 will indicate in the registration message that it sends to RF 208 that it operates within a 4G IMS and P-CSCF 120 will indicate in the registration message that it sends to RF 208 that it operates within a 5G IMS.

Step s302 comprises UE 102 sending a request message 302 that comprises IMS information indicating a particular IMS type (e.g. 5G IMS) that should serve the UE 102, wherein the request message 302 is received by MME 202. Request message 202 may be a 3GPP PDN Connectivity Request message.

Step s304 comprises MME 202 responding to request message 302 by transmitting to SGW 204 a request 304 that comprises IMS information indicating the particular IMS type that should serve the UE 102. Request 304 may be a 3GPP Create Session Request.

Step s306 comprises SGW 204 responding to request message 304 by transmitting to SMF 206 a request 306 that comprises IMS information indicating the particular IMS type that should serve UE 102. Request 306 may be a 3GPP Create Session Request.

Step s308 comprises SMF 206 sending to RF 208 a query message 308 (e.g., a 3GPP 5G Nnrf_NFDiscovery_Request message). In some embodiments query message 308 comprises IMS information indicating the particular IMS type that should serve the UE 102.

Step s310 comprises RF 208 responding to the query message 308 by generating a response message 310 that comprises a set of one or more addresses and sending to SMF 206 the response message, wherein each address in the set of addresses corresponds to a control function that operates within an IMS.

In the embodiments in which the P-CSCFs register with RF 208 by indicating the type of IMS within which the P-CSCF operates and the embodiments in which the query includes IMS information indicating the particular IMS type that should serve the UE 102, then the set of address provided by RF 208 may consists only of addresses that corresponds to a control function that operates within an IMS of the particular IMS type that should serve the UE 102.

In the embodiments in which the P-CSCFs does not register with RF 208 by indicating the type of IMS within which the P-CSCF operates or the query 308 does not include any IMS information indicating the particular IMS type that should serve the UE 102, then the set of address provided by RF 208 may comprise an address corresponding to 4G P-CSCF and an address corresponding to a 5G P-CSCF. In this scenario, the SMF 206 should ignore the P-CSCFs that operate within a type of IMS that does not match the type of IMS that should serve the UE.

Step 312 comprises SMF 206 responding to request 306 by transmitting a response 312 (e.g., a Create Session Response message) to SGW 204, wherein response 312 comprises a set of one or more addresses, wherein each address in the set of addresses corresponds to a control function that operates within an IMS of the particular type of IMS that should serve UE 102. As noted above, in some embodiments, SMF 206 obtains the set of address from RF 208. However, in other embodiments, SMF 206 is pre-configured with P-CSCF addresses. For example, SMF 206 may be pre-configured with a first set of P-CSCF addresses corresponding only to 4G P-CSCFs and a second set of P-CSCF addresses corresponding only to 5G P-CSCFs. In this embodiment, when SMF 206 gets request 306 comprising the IMS information indicating the particular IMS type that should serve UE 102, SMF 206 selects, based on the IMS information, from either the first or second set of addresses one or more addresses to provide to UE 102 (thus, steps s308 and s310 are not necessary in this embodiment).

Step s314 comprises SGW 204 responding to response 312 by transmitting to MME 202 a response 314 (e.g., Create Session Response) that comprises the set of addresses included in response 312.

Step s316 comprises MME 202 responding to response 314 by transmitting to UE 102 a response 316 (e.g., PDN Connectivity Accept) that comprises the set of addresses included in response 314.

Step s318 comprises UE 102 responding to response 316 by selecting an address from the set of addresses and transmitting to the P-CSCF to which the address corresponds an IMS registration message 318 (e.g., a Session Initiation Protocol (SIP) Register message).

As the above illustrates, it can be ensured that a VoLTE UE will be served by legacy 4G IMS and a 5G UE with 5G subscription will be served with 5G IMS.

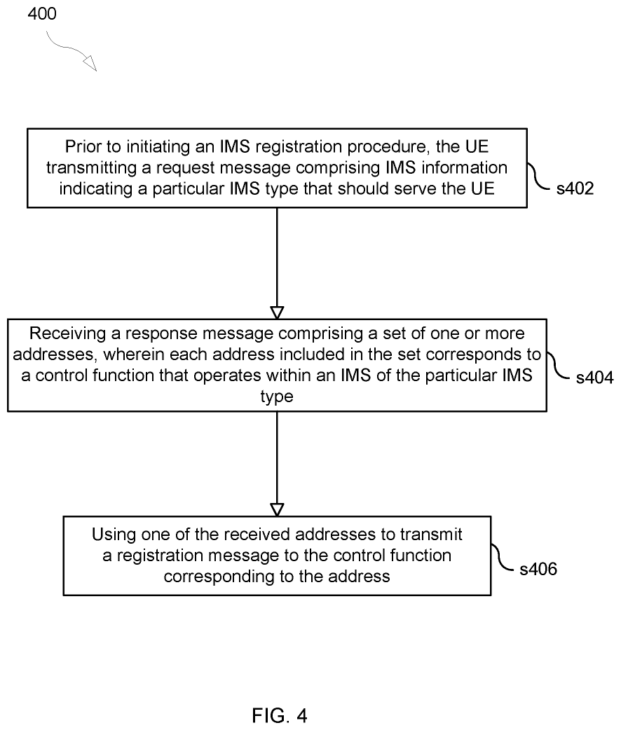

FIG. 4 is a flowchart illustrating a process 400 for registering with an Internet Protocol Multimedia Subsystem (IMS). Process 400 may begin in step s402.

Step s402 comprises UE 102, prior to initiating an IMS registration procedure, transmitting a request message (e.g., PDN Connectivity Request) comprising IMS information indicating a particular IMS type (e.g. 5G IMS) that should serve the UE.

In some embodiments, the IMS information indicating the particular IMS type comprises or consists of UE capability information declaring that the UE is capable of using an IMS of the particular IMS type (e.g., “IMS voice in 5GS capable”).

Step s404 comprises UE 102 receiving a response message (e.g., PDN Connectivity Accept). The response message may comprise a set of one or more addresses (e.g., IP addresses and/or domain names) and each address (e.g., each fully qualified domain name) included in the set may correspond to a control function that operates within an IMS of the particular IMS type.

Step s406 comprises UE 102 using one of the received addresses to transmit a registration message to the control function corresponding to the address.

In some embodiments, the control function is a Proxy Call Session Control Function, P-CSCF.

In some embodiments, the PDN Connectivity Request comprises a request for an address of a P-CSCF. For example, the PDN Connectivity Request may include a Protocol Configuration Options (PCO) information element (IE) that comprises information indicating that the UE is requesting at least one address of a P-CSCF.

In some embodiments, the response message is a Radio Resource Control (RRC) Connection Reconfiguration message, and the set of one or more addresses is contained within a PCO IE contained within the RRC Connection Reconfiguration message.

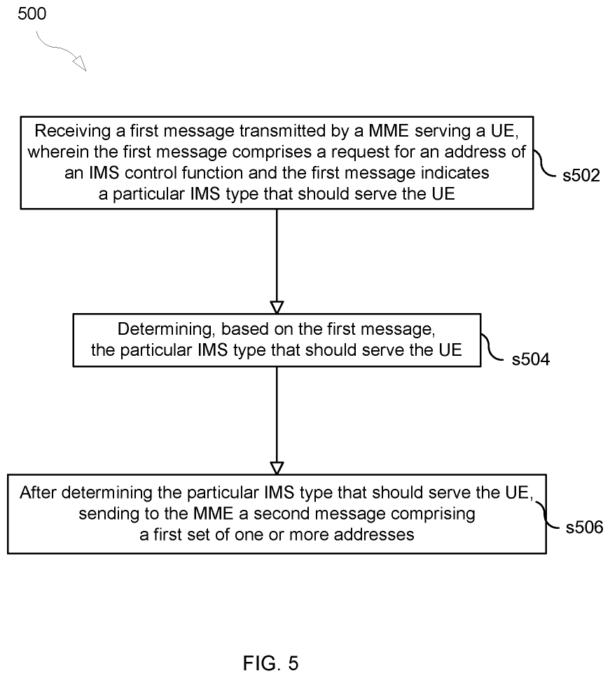

FIG. 5 is a flow chart illustrating a process 500 for enabling UE 102 to register with an IMS. Process 500 may begin in step s502.

Step s502 comprises SMF 206 receiving a first message transmitted by MME 202 serving the UE. The first message may comprise a request for an address of an IMS control function and may indicate a particular IMS type (e.g. 5G IMS) that should serve the UE.

Step s504 comprises SMF 206 determining, based on the first message, the particular IMS type (e.g. 5G IMS) that should serve the UE.

Step s506 comprises SMF 206, after determining the particular IMS type (e.g. 5G IMS) that should serve the UE, sending to the MME a second message comprising a first set of one or more addresses. Each address included in the first set of addresses may correspond to a control function that operates within an IMS of the particular IMS type.

In some embodiments, process 500 further comprises prior to sending the second message and after determining the particular IMS type, the SMF transmitting to an entity of a core network (e.g., a 3GPP 5G Network Repository Function (NRF)) a network function discovery request (e.g., a 3GP 5G Nnrf_NFDiscovery_Request message). Process 500 may further comprise the SMF receiving a response to the network function discovery request. The response may comprise a second set of addresses. Each address included in the second set of addresses may correspond to a control function that operates within an IMS.

In some embodiments, the network function discovery request comprises information indicating the particular IMS type, and each address included in the second set of addresses corresponds to a control function that operates within an IMS of the particular IMS type.

In some embodiments, the response further comprises, for each address included in the set of addresses, information specifying the type of IMS within which the control function corresponding to the address operates.

In some embodiments, process 500 further comprises the SMF forming the first set of addresses by selecting from the second set of address only those addresses in the second set of address that correspond to a control function that operates within an IMS of the particular IMS type.

In some embodiments, the first message transmitted by the MME is a Create Session Request and the MME transmitted the Create Session Request as a result of receiving a PDN Connectivity Request transmitted by the UE.

In some embodiments, the first message comprises UE capability information that indicates the particular IMS type.

In some embodiments, the UE capability information declares that the UE is capable of using an IMS of the particular IMS type.

In some embodiments, determining the particular IMS type comprises or consists of parsing the first message to obtain the UE capability information included in the first message.

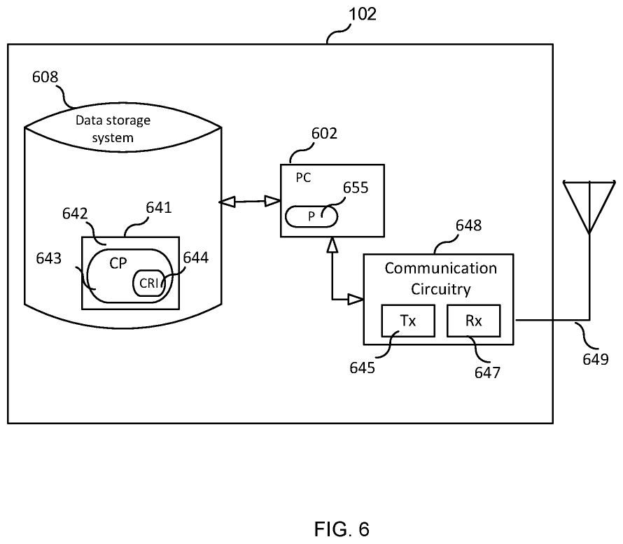

FIG. 6 is a block diagram of UE 102, according to some embodiments. As shown in FIG. 6, UE 102 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling UE 102 to transmit data and receive data (e.g., wirelessly transmit/receive data); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes UE 102 to perform steps described herein (e.g., steps described herein with reference to the flow charts). In other embodiments, UE 102 may be configured to perform steps described herein without the need for code. That is, for example, PC 602 may consist merely of one or more ASICs. Hence, the features of the embodiments described herein may be implemented in hardware and/or software.

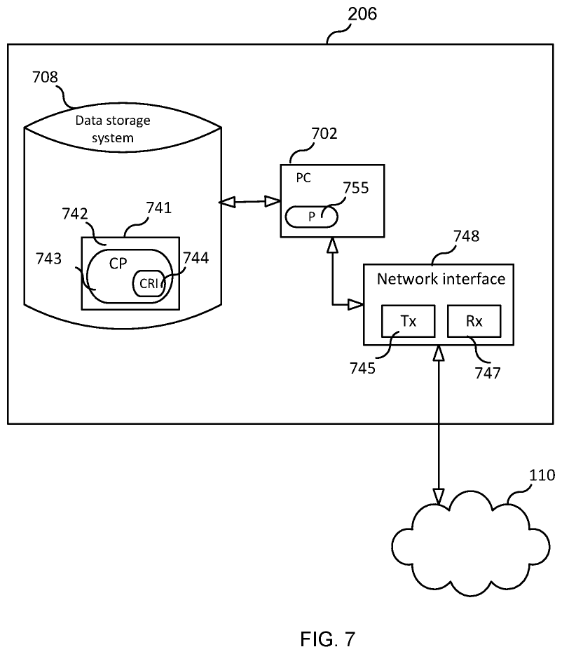

FIG. 7 is a block diagram of SMF 206 according to an embodiment. As shown in FIG. 7, SMF 206 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed; a network interface 748 comprising a transmitter (Tx) 745 and a receiver (Rx) 747 for enabling SMF 206 to transmit data to and receive data from other nodes connected to a network 110 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes SMF 206 to perform steps described herein (e.g., steps described herein with reference to the flow charts). In other embodiments, SMF 206 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE) for registering with an Internet Protocol Multimedia Subsystem (IMS), the method comprising:
prior to initiating an IMS registration procedure, the UE transmitting a request message comprising IMS information indicating a particular IMS type that should serve the UE;
receiving a response message comprising a set of one or more addresses, wherein each address included in the set corresponds to a control function that operates within an IMS of the particular IMS type; and
using one of the received addresses to transmit a registration message to the control function corresponding to the address.

2. The method of claim 1, wherein the IMS information indicating the particular IMS type comprises or consists of UE capability information declaring that the UE is capable of using an IMS of the particular IMS type.

3. The method of claim 1, wherein the request message is a PDN Connectivity Request.

4. The method of claim 3, wherein the control function is a Proxy Call Session Control Function, P-CSCF.

5. The method of claim 4, wherein the PDN Connectivity Request comprises a request for an address of a P-CSCF.

6. The method of claim 1, wherein
the response message is a Radio Resource Control (RRC) Connection Reconfiguration message, and
the set of one or more addresses is contained within a Protocol Configuration Options (PCO) information element of the RRC Connection Reconfiguration message.

7. A method for enabling a user equipment (UE) to register with an Internet Protocol Multimedia Subsystem (IMS), the method comprising:
a session management function (SMF) receiving a first message transmitted by a Mobility Management Entity (MME) serving the UE, wherein the first message comprises a request for an address of an IMS control function and the first message indicates a particular IMS type that should serve the UE;
the SMF determining, based on the first message, the particular IMS type that should serve the UE; and
the SMF, after determining the particular IMS type (e.g. 5G IMS) that should serve the UE, sending to the MME a second message comprising a first set of one or more addresses, wherein each address included in the first set of addresses corresponds to a control function that operates within an IMS of the particular IMS type.

8. The method of claim 7, further comprising:
the SMF, prior to sending the second message and after determining the particular IMS type, the SMF transmitting to an entity of a core network a network function discovery request; and
the SMF receiving a response to the network function discovery request, wherein the response comprises a second set of addresses, wherein each address included in the second set of addresses corresponds to a control function that operates within an IMS.

9. The method of claim 8, wherein
the network function discovery request comprises information indicating the particular IMS type, and
each address included in the second set of addresses corresponds to a control function that operates within an IMS of the particular IMS type.

10. The method of claim 8, wherein
the response further comprises, for each address included in the set of addresses, information specifying the type of IMS within which the control function corresponding to the address operates, and
the method further comprises the SMF forming the first set of addresses by selecting from the second set of address only those addresses in the second set of address that correspond to a control function that operates within an IMS of the particular IMS type.

11. The method of claim 7, wherein the first message transmitted by the MME is a Create Session Request and the MME transmitted the Create Session Request as a result of receiving a PDN Connectivity Request transmitted by the UE.

12. The method of claim 7, wherein the first message comprises UE capability information that indicates the particular IMS type.

13. The method of claim 12, wherein the UE capability information declares that the UE is capable of using an IMS of the particular IMS type.

14. The method of claim 12, wherein determining the particular IMS type comprises or consists of parsing the first message to obtain the UE capability information included in the first message.

15. The method of claim 8, wherein
the second set of addresses includes a first address corresponding to a first control function, and
the method further comprises:
prior to the SMF sending the network function discovery request, the first control function sending to the entity a registration message comprising IMS information indicating a particular IMS type, wherein the IMS in which the first control function operates is an IMS of the particular IMS type indicated by the IMS information included in the registration message sent to the entity.

16. The method of claim 15, wherein the registration message is a 3GPP Nnrf_NFManagement_NFRegister Request message.

17. A user equipment (UE) for registering with an Internet Protocol Multimedia Subsystem (IMS), the UE being configured to:
prior to initiating an IMS registration procedure, transmit a request message comprising IMS information indicating a particular IMS type that should serve the UE;
receive a response message comprising a set of one or more addresses, wherein each address included in the set corresponds to a control function that operates within an IMS of the particular IMS type; and
use one of the received addresses to transmit a registration message to the control function corresponding to the address.

18. A session management function (SMF) for enabling a user equipment (UE) to register with an Internet Protocol Multimedia Subsystem (IMS), the SMF being configured to:
receive a first message transmitted by a Mobility Management Entity (MME) serving the UE, wherein the first message comprises a request for an address of an IMS control function and the first message indicates a particular IMS type that should serve the UE;
determine, based on the first message, the particular IMS type that should serve the UE; and
after determining the particular IMS type that should serve the UE, send to the MME a second message comprising a first set of one or more addresses, wherein each address included in the first set of addresses corresponds to a control function that operates within an IMS of the particular IMS type.

19. A non-transitory computer readable medium storing a computer program comprising instructions for configuring an apparatus to perform the method of claim 1.

20. (canceled)
